(19) United States
(12) Patent Application Publication
(10) Pub. No.: US 2011/0131539 A1
(43) Pub. Date: Jun. 2, 2011

(54) REWIRING USING IRREDUNDANCY REMOVAL AND ADDITION

(75) Inventors: Chun-Yao WANG, Hsin Chu City (TW); Chun-Chi LIN, Hsin Chu City (TW); Daw-Ming LEE, Hsin Chu City (TW)

(73) Assignee: NATIONAL TSING HUA UNIVERSITY, Hsin Chu (TW)

(21) Appl. No.: 12/626,801

(22) Filed: Nov. 27, 2009

(51) Int. Cl. G06F 17/50

(52) U.S. Cl. 716/100

(57) ABSTRACT

This invention proposes a new restructuring technique, Rewiring Using IRredundancy Removal and Addition (IRRA) used in the synthesis and optimization of logic designs. This method successfully removes any desired target wire by constructing a corresponding rectification network which exactly corrects the error of the circuit caused by the removal of the target wire. The rectification network can be further simplified to achieve excellent area optimization.

### REFERENCES

[1] C.-W. Jim Chang, M.-F. Hsiao, and M. Marek-Sadowska, “A New Reasoning Scheme for Efficient Redundancy Addition and Removal,” IEEE Trans. Computer-Aided Design, vol. 22, pp. 945-952, July 2003.
[2] S.-C. Chang, K.-T. Cheng, N.-S Woo, and M. Marek-Sadowska, “Postlayout Logic Restructuring Using Alternative Wires,” IEEE Trans. Computer-Aided Design, vol. 16, pp. 587-596, June 1997.
[3] K. T. Cheng and L. A. Entrena “Multi-level Logic Optimization by Redundancy Addition and Removal,” in Proc. Europ. Conf. Design Automation, pp. 373-377, 1993.
[4] S.-C. Chang, M. Marek-Sadowska, and K.-T. Cheng, “Perturb and Simplify: Multi-level Boolean Network Optimizer,” IEEE Trans. Computer-Aided Design, vol. 15, pp. 1494-1504, December 1996.
[5] S.-C. Chang, L. P. P. P. Van Ginneken, and M. Marek-Sadowska, “Fast Boolean Optimization by Rewiring,” in Proc. Int. Conf. Computer-Aided Design, pp. 262-269, 1996.
[6] Y.-C Chen and C.-Y Wang, “An Improved Approach for Alternative Wires Identification,” in Proc. Int. Conf. Computer Design, pp. 711-716, 2005.
[7] L. A. Entrena and K.-T. Cheng, “Combinational and Sequential Logic Optimization by Redundancy Addition and Removal,” IEEE Trans. Computer-Aided Design, vol. 14, pp. 909-916, July 1995.
[8] T. Kirkland and M. R. Mercer, “A Topological Search Algorithm for ATPG,” in Proc. Design Automation Conf., pp. 502-508, 1987.
[9] W. Kunz and D. K. Pradhan, “Recursive Learning: An Attractive Alternative to the Decision Tree for Test Generation in Digital Circuits”, in Proc. Int. Test Conf., pp. 816-825, 1992.
[10] E. M. Sentovich, K. J. Singh, L. Lavagno, C. Moon, R. Murgai, A. Saldanha, H. Savoj, P. R. Stephan, R. K. Brayton, and A. Sangiovanni-Vincentelli, “SIS: A System for Sequential Circuit Synthesis,” Technical Report UCB/ERL M92/41, Electronics Research Lab, Univ. of California, Berkeley, Calif. 94720, May 1992.
[11] A. Veneris and M. S. Abadir, “Design Rewiring Using ATPG”, IEEE Trans. Computer-Aided Design, vol. 21, pp. 1469-1479, December 2002.
[12] A. Veneris, J. B. Liu, M. Amiri and M. S. Abadir, “Incremental Diagnosis and Debugging of Multiple Faults and Errors”, in Proc. Design, Automation and Test in Europe, pp. 716-721, 2002.

### BACKGROUND

1. Field of the Invention

This invention relates generally to digital logic network optimization. More particularly, the present invention relates to a reconstructing technique used in the synthesis and optimization of logic designs which can remove and add wire in the circuit. This circuit rewiring technique is successful especially in area reduction of the circuit.

2. Description of the Prior Art

The well known network optimization techniques, redundancy addition and removal (RAR) technique, first described in K.-T. Cheng and L. A. Entrena, Multi-Level Logic Optimization by Redundancy Addition and Removal, Proc. European Conf. on Design Automation (1993) at 373-77 and incorporated by reference herein, provides a most effective method for optimizing a network. RAR identifies redundant connections which can be added to a network that create a greater number of redundancies which can be removed from the network and allows for the simultaneous addition and removal of redundancies during optimization. RAR also provides a technique for multi-level minimization of sequential circuits without any restrictions in their structure.

Redundancy Addition and Removal (RAR) is a technique for reconstructing a circuit by adding some redundant wires or gates, named alternative wire/gates, and resulting in the removal of given target wires. In the process of RAR, the addition and the removal of redundant wires would restructure a circuit without changing the functionality. This circuit transformation technique is applicable to achieve optimization objectives such as area, timing, power, or reliability (references [2] [3] [4] [5] [7]) of VLSI circuits.

One of the most commonly used approaches to RAR is Automatic Test Pattern Generation (ATPG)-based algorithm due to little memory requirement for large circuits. ATPG-based approaches can be divided into two-stage algorithms and one-stage algorithms. In two-stage algorithms (references [2] [3] [4] [5] [7]), a set of candidate wires that can make the target wire become redundant is built up by the Mandatory Assignments (MAs) calculated from the stuck-at fault test on the target wire. Then, redundancy tests on each candidate wire are performed. It requires much effort in the redundancy tests while the candidate set is large. Reducing unnecessary redundancy tests by pruning the candidate set is a solution to improve the efficiency of two-stage algorithms. Nevertheless, the effort for redundancy tests on the remaining candidate wires is still required. On the other hand, one-stage algorithms (references [1] [6]) identify alternative wires without redundancy tests, and they significantly reduce the CPU time. However, the rewiring capability is not as good as that of two-stage algorithms.

A target wire has an alternative wire if the target wire become redundant, thus can be removed, after adding a redundant wire to the circuit. The capability of ATPG-based RAR for alternative wire identification is limited by the identified MAs. If a target wire does not have an alternative wire since the condition of MA is unsatisfied, the target wire cannot be removed (reference [3]). Thus, an approach with multiple wires/gates addition is proposed in the reference [4], for boosting the removal capability of the target wire. But it still only considers the gates that are the MAs when searching the candidates for addition.

Redundancy Addition and Removal (RAR) and ATPG/Diagnosis-based Design Rewiring (ADDR) are both restructuring techniques used in the synthesis and optimization of logic designs. They can remove an existing target wire and add another absent alternative wire in the circuit such that the functionality of the circuit is intact. However, not every irredundant target wire can be successful removed due to some limitations in these two approaches. Furthermore, the necessity of verification is another drawback for validating this restructuring in the ADDR algorithm.

In view of the aforementioned drawbacks, the present invention proposes a new restructuring technique which successfully removes any desired target wire by constructing a corresponding rectification network which exactly corrects the error of the circuit caused by the removal of the target wire.

### SUMMARY OF THE INVENTION

The first step of IRRA process is to remove any target wire first, then it adds another irredundant wire/network to rectify the functionality of the circuit. The most important step in IRRA is how to recognize the addition of this another irredundant wire (network) which can rectify the functionality of the circuit. That is, how to derive the rectification network with respect to the inject error by the first removed irredundant wire.

The process of RAR is to add redundant wire first, then remove the target which becomes redundant due to the additions. Here, we provide a new point of view in dealing such kind of issue. From the opposite direction the, RAR can be viewed as a process of removing the irredundant target wire first, then adding other irredundant wire to rectify the functionality of the circuit.

The IRRA process comprises the steps of: selecting an irredundant target wire in a circuit; removing the irredundant target wire by constructing a corresponding rectification network; adding a redundant wire in a circuit; applying stuck-at fault test on the redundant wire. Furthermore, to simplified the rectification network, the present invention comprises SMA classification step and SMA substitution step.

The method and its steps will become apparent from the following detailed description. It should be understand, however, that the detailed description and the specific examples, while indicating the preferred embodiments of the present invention, are given by way of illustration only, since various changes and modification within the spirit and scope of the present invention will become apparent to those skilled in the art from this detailed description.

### BRIEF DESCRIPTION OF THE DRAWINGS

The above objects, and other features and advantages of the present invention will become more apparent after reading the following detailed descriptions when taken in conjunction with the drawings, in which:

FIG. 1 is an example of IRRA.

FIG. 2 is an example of EAN and ERN.

FIG. 3a is the K-map of the output before removing the target wire in FIG. 2.

FIG. 3b is the K-map of the output after removing the target wire in FIG. 2.

FIG. 4a is the general scheme of the rectification network.

FIG. 4b is the general scheme of the simplified rectification network.

FIG. 5a is the IRRA scheme for alternative wires.

FIG. 5b is the IRRA scheme for alternative wires.

FIG. 6a˜6d is an example of SMA classification and SMA substitution.

FIG. 7a˜FIG. 7d illustrate the types of SMA substitution in an AND gate.

FIG. 8a˜FIG. 8d illustrate the types of SMA substitution in an OR gate.

FIG. 9 illustrates a graph of the area optimization for the circuit alu2.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

The present invention proposes a new restructuring technique, IRredundancy Removal and Addition (IRRA), which successfully removes any desired target wire by constructing a corresponding rectification network which exactly corrects the error of the circuit caused by the removal of the target wire. The IRRA technique is also applied in two applications in the present invention—single alternative wire identification and area optimization. The experimental results show that the IRRA approach is more efficient and more effective compared to the reference [6] for single alternative wire identification in this untuned prototype implementation. For area optimization, the results are very encouraging compared to SIS and the reference [4]

The present invention proposes an ATPG-based logic restructuring technique, IRRA. IRRA can remove any desired target wire and use a formal method to rectify the error due to the removal of the target wire. A single alternative wire identification procedure is also proposed from the IRRA technique. The experimental results show the effectiveness and efficiency of our approach of the present invention as compared with the state of the prior art. The application of area optimization with the IRRA technique is also demonstrated in the present invention. It is very promising that the characteristic of IRRA allows restructuring the circuits more widely such that different optimization objectives can be achieved.

The RAR technique is viewed in an opposite way where it removes an irredundant target wire first and then adds an irredundant wire to rectify the functionality of the circuit. From this point of view, a technique of IRredundancy Removal and Addition (IRRA) for circuit restructuring is proposed. IRRA is an ATPG-based technique that can remove any desired irredundant target wire and rectifies the erroneous functionality due to the removal of the target wire by adding some wires/gates. These added wires/gates are named rectification network. Thus, RAR is a special case of IRRA where the rectification network is just an alternative wire.

The idea of IRRA is similar to ATPG/Diagnosis-based Design Rewiring (ADDR) (reference [11]). The ADDR algorithm is summarized as follows. A design error is injected first, where the error is represented by the removal of an irredundant target wire. Then a set of test vectors for the design error is generated by ATPG. The third step uses a simulation-based Design Error Diagnosis and Correction (DEDC) heuristic (reference [12]) to search the possible corrections for the error. In the last step, the transformed circuit with the correction is verified against the original circuit. Although ADDR algorithm expects to perform a wide variety of logic transformations by introducing and correcting an error, it still has some limitations. Namely, if the error cannot be corrected by the DEDC algorithm, the target wire still can not be removed. Furthermore, the requirement of verification between the original circuit and the transformed circuit is another drawback. In the proposed IRRA approach, a formal method rather than the simulation-based DEDC heuristic is to rectify the error. Thus, it is not necessary to verify the functionality of the restructured circuit again.

Now, notations and terminologies are described below. A Boolean network is a Directed Acyclic Graph (DAG) where each node ni is associated with a Boolean variable yi and a Boolean function ƒi. There exists a connection directed from node ni to node nj if the function ƒj depends on the variable yi. An input to a gate has a controlling value if the value of the gate's output is determined by the input regardless of the other inputs. The noncontrolling value is the inverse of the controlling value. For example, the controlling value of AND gate is 0 and the noncontrolling value is 1.

The dominators (reference [8]) of a wire w is the set of gates G such that all paths from the wire w to any primary outputs have to pass through all gates in G. Consider the dominators of a wire w, the fault propagating inputs of a dominator are the inputs in the transitive fanout of w, and the other inputs are side inputs of the dominator. In the process of test generation for a stuck-at fault at a wire w (gi→gj), gi must be assigned to a controlling value to activate the fault effect and all side inputs of w's dominators must be assigned to noncontrolling values to propagate the fault effect.

The mandatory assignments are the unique value assignments required for a test to exist. The logic implication is a process of computing MAs for a test. A known logic value can be propagated forward and backward until no more logic values can be implicated. The MAs for a stuck-at fault test on a wire w can be computed from setting fault-activating value and setting noncontrolling values on the side inputs of w's dominators. Then the MAs can be propagated forward or backward to obtain more MAs. Recursive learning (reference [9]) can be applied to find more MAs. Forced MA (reference [5]) that causes the target fault untestable while violating it. The MAs obtained by activating the fault effect and setting noncontrolling values on side inputs of w's dominators are forced. The MAs obtained by backward implications are also forced. The necessary condition for a redundant wire to be an alternative wire for the target wire is to violate forced MAs (reference [5]).

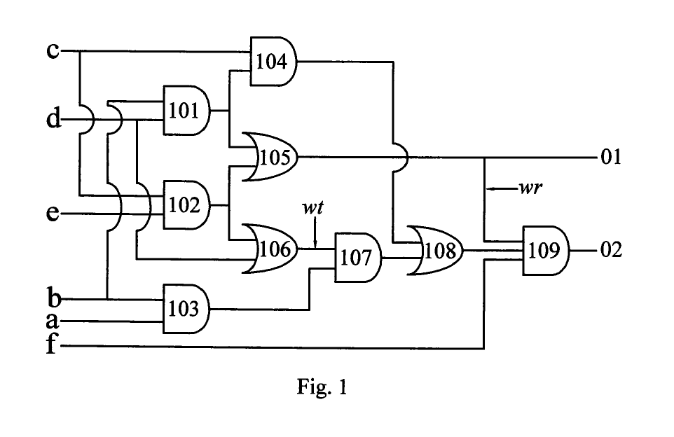

Following, the irredundancy removal and addition is introduced. The process of RAR is to add redundant wires first, then remove the target wire which becomes redundant due to the wire additions. From the opposite direction, RAR can be viewed as a process of removing the irredundant target wire first, then adding other irredundant wires to rectify the functionality of the circuit. For example in FIG. 1, supposing the irredundant target wire to be removed is wt (g6→g7). The process of RAR is to add a redundant wire wr (g5→g9) first in the circuit. This addition makes wt become redundant. Then wt is removed as desired. For the process of IRRA, however, it removes this irredundant target wire wt first, then it adds another irredundant wire wr to rectify the functionality of the circuit. The most important step in IRRA process is how to recognize the addition of wr (g5→g9) can rectify the functionality of the circuit. That is, how to derive the rectification network with respect to the injected error.

The requirements to rectify the functionality of the circuit after the removal of a target wire wt is described. Assume a stuck-at v fault is introduced at the target wire wt (ns→nd), where v is 1 {0} if nd is an AND {OR} gate. To generate a test vector for the fault at wt, the MAs for wt are calculated. Among the MAs, Source MAs are defined as follows which will be used in our approach of the present invention.

Definition 1: Given a set of MAs for a target fault, the source MA (SMA) is defined as an MA whose transitive fanin cone contains no other MAs.

In one embodiment, for example, in FIG. 1 it shows an example of IRRA, with six AND gates g1 101, g2 102, g3 103, g4 104, g7 107 and g9 109, three OR gates g5 105, g6 106 and g8 108 and six primary inputs a, b, c, d, e and f. Supposing the target wire to be removed is wt (g6→g7). Then a stuck-at −1 fault is set on wt (g6→g7). The MAs for the test are {g6=0, g2=0, d=0, g1=0, g5=0, g4=0, g3=1, a=1, b=156, ƒ=1}. Since the transitive fanin cones of the MAs {g2=0, d=0, a=1, b=156, ƒ=1} contain no other MAs, these five MAs are SMAs.

After calculating MAs and SMAs, a destination gate gd is selected on which the rectification network is added. The destination is selected from the dominators of wt since a dominator is where the error must pass through. In the present invention, the gates of AND, OR and INV are only considered and the error is the removal of the target wire. Thus, the target wire contains at least one dominator, namely, the output gate of the target wire. There always exists at least one destination for the error.

Supposing the original circuit is called the good circuit and the circuit after the removal of wt is called the faulty circuit. To rectify the functionality of the circuit at gd, the differences between the good circuit and the faulty circuit at gd must be identified. The differences at gd are the minterms that changed from 0 to 1, and that changed from 1 to 0 after the removal of wt. Thus, two networks are defined to represent these differences.

Definition 2: Given a Boolean network, a target wire, and a destination gate gd in the dominators of the target wire. The Exact Addition Network (EAN) at gd is defined as the network having minterms changed from 0 to 1 at gd after removing the target wire. The Exact Removal Network (ERN) at gd is defined as the network having minterms changed from 1 to 0 at gd after removing the target wire.

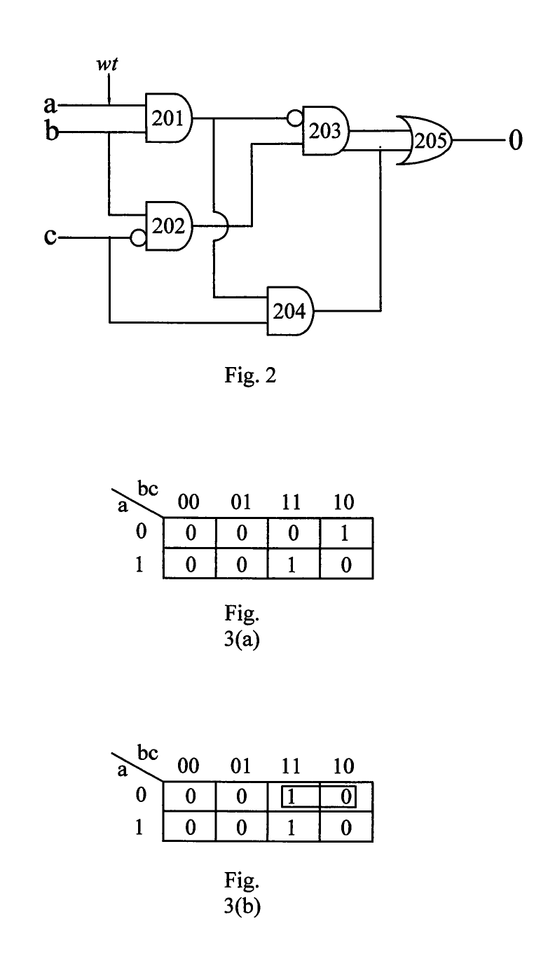

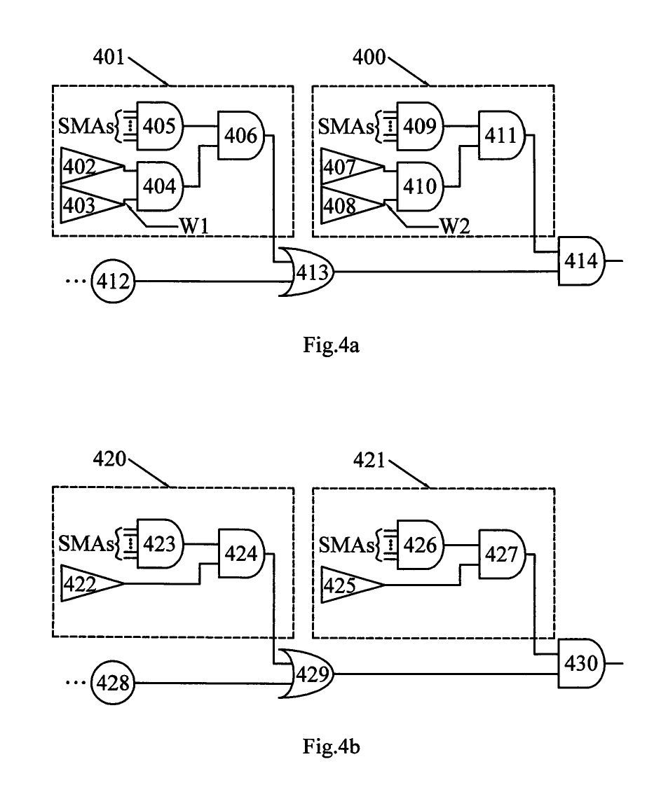

For example, in FIG. 2, it shows an example of EAN and ERN, with four AND gates g1 201, g2 202, g3 203, g4 204, one OR gates g5 205 and three primary inputs a, b, c. Supposing the target wire to be removed is wt (a→g1) and the destination gate gd is a dominator of wt, g5. FIGS. 3a and 3b are the K-maps of function at g5 before and after the removal of wt respectively. We can find ābc is the minterm changed from 0 to 1 and āb c̅ is the minterm changed from 1 to 0. Thus, the EAN is the network composed of ābc, and ERN is the network composed of āb c̅. Theorem 1 describes how to derive the EAN and ERN from the circuit after the removal of a target wire.

Theorem 1: Given a Boolean network, a target wire wt, and a destination gate gd in the dominators of the target wire. Supposing the cofactors of gd with respect to SMA in good/faulty circuits are denoted as gd_{g(SMA)} and gd_{ƒ(SMA)}, respectively, and the product of all SMAs is denoted as AND(SMA). The Boolean function of EAN at gd is

AND(SMA)· g̅d̅_̅{̅g̅(̅S̅M̅A̅)̅}̅·gd_{ƒ(SMA)} (1)

The Boolean function of ERN at gd is

AND(SMA)·gd_{g(SMA)}· g̅d̅_̅{̅ƒ̅(̅S̅M̅A̅)̅}̅ (2)

Proof: The AND(SMA) term can represent all MAs since these MAs can be derived from the SMAs by logic implication, and they are unique values for a stuck-at fault test on wt. This means that the minterms to be changed are only under the cofactors with respect to SMAs. Then g̅d̅_̅{̅g̅(̅S̅M̅A̅)̅}̅ means the network represents all minterms of 0 at gd before removing wt. gd_{ƒ(SMA)} means the network represents all minterms of 1 at gd after removing wt. Thus, the EAN formula is derived as equation (1). The ERN formula is proved in the same manner and is derived as equation (2).

For example, in FIG. 2, supposing the target wire to be removed is wt (a→g1) and the destination gate gd is g5. Since g1 is an AND gate, a stuck-at −1 fault is set on wt(a→g1). The MAs for the test are {a=0, b=1}. These MAs are both SMAs. The cofactors of g5 with respect to a=0 and b=1 in the good/faulty circuits are c̅c/c. Thus, the EAN at g5 is āb· c̅·c=ābc, and the ERN at g5 is āb· c̅· c̅=āb c̅.

Theorem 2: Given a Boolean network, a target wire wt, a destination gate gd in the dominators of the target wire, the EAN at gd, and the ERN at gd. The functionality of (gd+ERN)· E̅A̅N̅ after removing wt is equivalent to that of the original network.

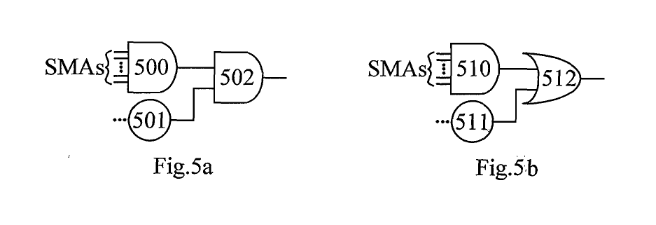

Proof: All minterms that are changed from 1 to 0 at gd will be changed from 0 to 1 after ORing the ERN. All minterms that are changed from 0 to 1 at gd will be changed from 1 to 0 after ANDing the EAN. Thus, the error introduced by the removal of wt can be corrected as (gd+ERN)· E̅A̅N̅. For the last example in FIG. 2, the EAN at gd is ābc and the ERN at gd is āb c̅. ORing the ERN will add the minterm āb c̅ to the faulty circuit. ANDing the EAN will remove the minterm āb c̅ from the faulty circuit. Thus, the faulty circuit is corrected to the good one. The general scheme of the rectification network is as shown in FIG. 4a. The left part is the ERN 401 with AND gates g1 404, g5 405, g6 406, and the right part is the EAN 400 with AND gates g2 410, g5 409, and 411. They are connected as Theorem 2 suggests.

Corollary 1: Given a Boolean network, a target wire wt, a destination gate gd in the dominators of the target wire, the EAN at gd, and the ERN at gd. The order of adding ERN and E̅A̅N̅ is irrelevant. Namely, the network (gd+ERN)· E̅A̅N̅ can be expressed as gd· E̅A̅N̅+ERN after removing wt. The minterms of the EAN and ERN do not overlap, thus the order of adding ERN and E̅A̅N̅ is irrelevant. The formula can also be deduced by Boolean manipulation as follows:

$$\begin{matrix}( gd + ERN ) \cdot \overline{EAN} = gd \cdot \overline{EAN} + ERN \cdot \overline{EAN} \\ = gd \cdot \overline{EAN} + ( AND ( SMA ) \cdot {gd}_{g ( SMA )} \cdot \overline{{gd}_{f ( SMA )}} \cdot \\ \overline{( AND ( SMA ) \cdot \overline{{gd}_{g ( sma )}} \cdot {gd}_{f ( sma )}} ( AND ( SMA ) \cdot \\ {gd}_{g ( SMA )} \cdot {gd}_{f ( SMA )} \\ = gd \cdot \overline{EAN} + ( AND ( SMA ) \cdot {gd}_{g ( SMA )} \cdot \\ \overline{{gd}_{f ( SMA )}} \cdot \overline{AND ( SMA )} + {gd}_{g ( SMA )} + \overline{{gd}_{f ( SMA )}} \\ = gd \cdot \overline{EAN} + 0 + AND ( SMA ) \cdot {gd}_{g ( SMA )} \cdot \\ \overline{{gd}_{f ( SMA )}} + AND ( SMA ) \cdot {gd}_{g ( SMA )} \cdot \overline{{gd}_{f ( SMA )}} \\ = gd \cdot \overline{EAN} + AND ( SMA ) \cdot {gd}_{g ( SMA )} \cdot \overline{{gd}_{f ( SMA )}} \\ = gd \cdot \overline{EAN} + ERN\end{matrix}$$

The Boolean formulae of EAN and ERN in Theorem 1 can be further simplified as stated in Theorem 3. The general scheme of the simplified rectification network is as shown in FIG. 4b. EAN 420 includes gd_{g(SMA)} 422, AND gates 423, 424, and ERN 421 includes gd_{g(SMA)} 425, AND gates 426, 427.

Theorem 3: Given a Boolean network, a target wire wt and a destination gate gd in the dominators of the target wire. The EAN at gd can be simplified from the equation (1) to

AND(SMA)· g̅d̅_̅{̅g̅(̅S̅M̅A̅)̅}̅ (3)

The ERN at gd can be simplified from the equation (2) to

AND(SMA)·gd_{g(SMA)} (4)

Proof: We prove this theorem by showing that the wires w1 in ERN, and w2 in EAN of FIG. 4a are both redundant. Thus, the rectification network can be simplified as FIG. 4b. In FIG. 4a, a stuck-at 0 test on w1(gd_{ƒ(SMA)}→g1) is performed. gd_{ƒ(SMA)} 403 has an MA of 1 to activate the fault. All SMAs and gd_{ƒ(SMA)} 402 are 1s to propagate the fault effect. Since the SMAs are 1s and the current circuit is faulty by removing the target wire, the value of gd in the bottom of FIG. 4a is the same as gd_{ƒ(SMA)} and equals 1. However, for propagating the fault effect in the OR gate g3, gd has to be 0. This causes a conflict on gd value. Thus, w1(gd_{ƒ(SMA)}→g1) is a redundant wire, and the ERN formula in the equation (2) can be simplified as the equation (4).

For the redundancy test of wire w2(gd_{ƒ(SMA)}→g2) in FIG. 4a, a stuck-at 1 fault is set on it. The MAs of the fault are {gd_{ƒ(SMA)} 403=0, gd_{g(SMA)}402=0, g5 405=1, g3 413=1, g1 404=0, g6 406=0, gd 412=1}. Again, since the value of gd represents gd_{ƒ(SMA)}, an MA inconsistency occurs. Thus, w2(gd_{ƒ(SMA)}→g2) is a redundant wire, and the EAN formula in the equation (1) can be simplified as the equation (3).

Following, the single alternative wire identification by using the IRRA approach is described. The IRRA idea is applicable to this problem and has a better performance. In the RAR, a redundant wire wr(ns→nd) is an alternative wire for wt, if and only if an AND {OR} gate nd has a forced MA 1 or D {0 or D̅} and ns has an MA 0{1} for the stuck-at fault test on wt (reference [5]). D represents 0/1 in the good/faulty circuit, and D represents 1/0 in the good/faulty circuit. If the addition of a wire can block the fault effect propagation of the target fault, this wire is a Forward Alternative Wire (FAW) of the target wire. If the addition of a wire violates a forced MA and then makes the MAs of the target fault inconsistent, this wire is a Backward Alternative Wire (BAW) of the target wire.

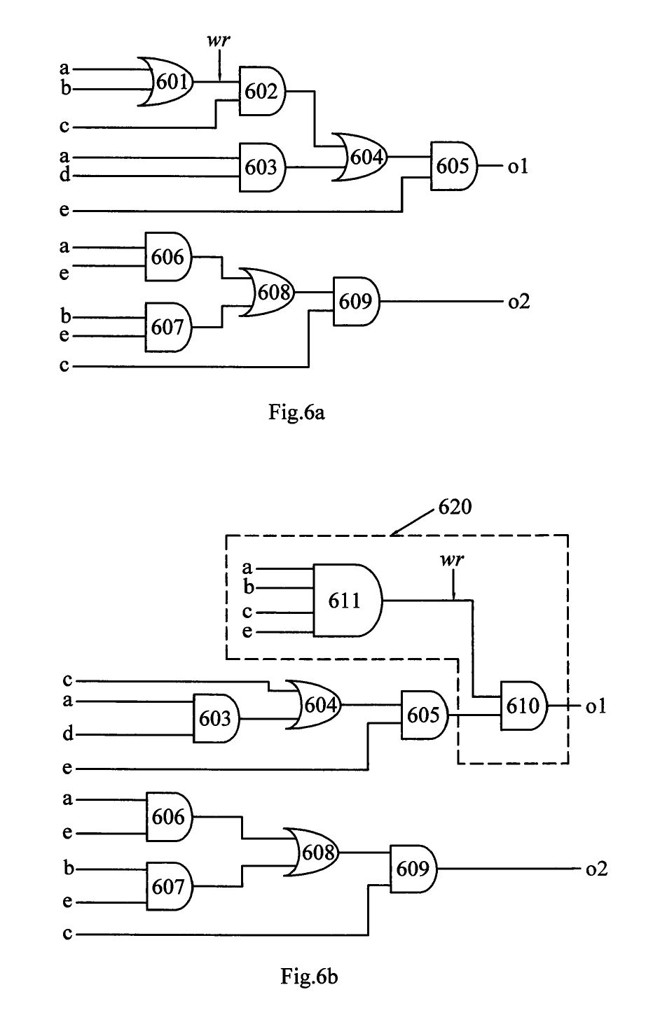

In the IRRA, if the destination gate gd in FIG. 4b, which is selected from the dominators of the target wire, has an MA D { D̅}, the value of gdg(SM A) will be 0 {1}. This causes the ERN {EAN} be a constant 0 network and the EAN {ERN} only leave the AND(SMA) term. Thus, the scheme becomes FIG. 5a (FIG. 5b). The AND(SMA) term 500, 510 in FIG. 5a and FIG. 5b can be seen as a gate that has an MA 1 and this MA will block the fault effect propagated from gd 501, 511 at gn 502, 512, respectively. Thus, the wire (AND(SMA)→gn) is the FAW of the target wire if gd has an MA D { D̅}. On the other hand, if the destination gate gd which is not a dominator has a forced MA 1 {0}, we can also violate the forced MA by adding the AND(SMA) term in the IRRA scheme. The scheme is also as FIG. 5a (FIG. 5b). The output of newly added gate gn will replace the original output of gate gd in the schemes. Thus, gn also has a forced MA 1 {0} while disconnecting the AND(SMA) term. But AND(SMA) term is added into the schemes in FIG. 5, the MA 1 of AND(SMA) term will cause the gn value become 0 {1} that violates the forced MA 1 {0} at gn. Thus, the wire (AND(SMA)→gn) is the BAW of the target wire if gd has a forced MA 1 {0}.

Note that not all forced MAs are the destinations for BAW addition. If the destination gate gd is a dominator, we can ensure that the rectification network will not affect the functionality of the gates which are not in the transitive fanout cone of the target wire. However, if the destination gate gd is not a dominator, but has a forced MA, the rectification network may change the functionality of these gates. Thus, the destinations with a forced MA will be examined whether the rectification network changes the functionality of the gates which are not necessary for correction. For example, supposing a target wire can only affect the functionality of the primary output o1. But the rectification network is added at a forced MA destination where this destination gate can reach the primary output of and o2. Thus, the rectification network may change the functionality of the primary output o2.

To find single alternative wires of a target wire, the AND(SMA) term in FIG. 5 must be reduced to only one MA. This can be achieved by SMA classification and SMA substitution procedures described in the followings.

Next, SMA classification is described.

Not every SMA must be included in the IRRA schemes in FIG. 5. Some of them are redundant under a particular condition and can be removed. SMAs are classified into two types in the present invention. The first type is irredundant SMA, which is irredundant after the removal of the target wire and is essential for rectifying the functionality. The second type is redundant SMA, which is redundant after the removal of the target wire. The redundant SMA can be removed directly for minimizing the rectification network. An SMA is redundant if the irredundant SMAs in the AND(SMA) term are don't care values when performing the stuck-at fault test on this SMA. Redundant SMA is the MA that can be implied by setting the noncontrolling value to the side inputs while performing the stuck-at-fault test at the wire (AND(SMA)→gn) in FIG. 5. With the SMA classification, the rectification network can be reduced to the term that only remains irredundant SMAs.

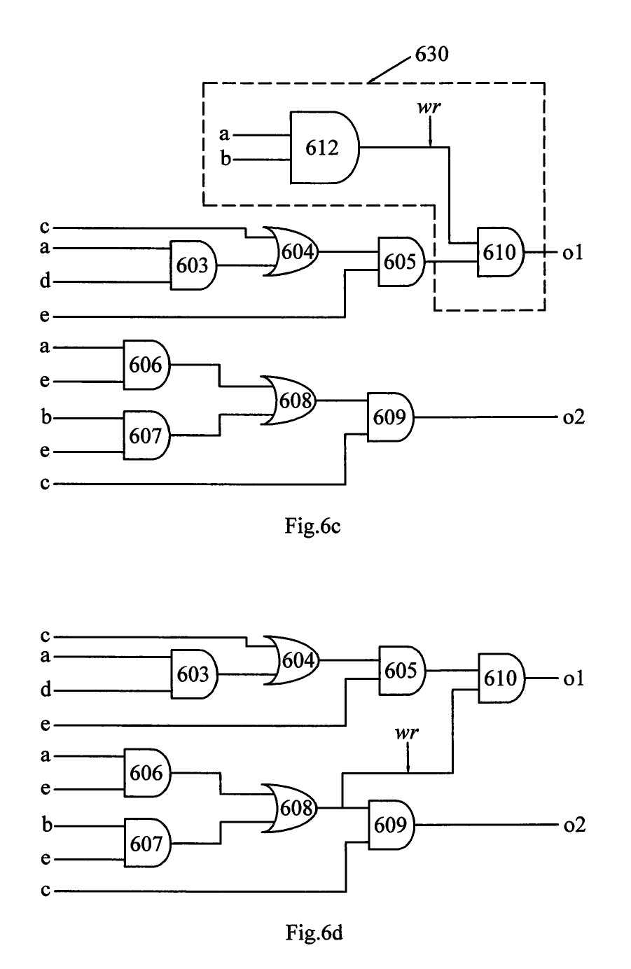

For example in FIG. 6(a), supposing the target wire to be removed is wt(g1→g2). Since g2 is an AND gate, a stuck-at −1 fault is set on wt(g1→g2). The MAs for the test are {g1 601=0, a=0, b=0, g3 603=0, g6 606=0, g7 607=0, g8 608=0, g9 609=0, c=1, e=1}. The SMAs are {a=0, b=0, c=1, e=1}. Since g5 605 has D value, by referring FIG. 5a, the initial rectification network 620 to correct the fault due to the removal of wt is as shown in FIG. 6b. The SMA a is an irredundant SMA since the stuck-at 0 test on the wire (a→g10 611) is testable. The SMA b is also an irredundant SMA due to the same reason. Next, the stuck-at 1 test on the wire (e→g10) is performed. e has an MA 0 to activate the fault effect. The wire (e→g10) is redundant since e=0 implies g5 605=0 and the fault effect is blocked at g11 610. Since the irredundant SMAs a and b are don't care values in determining the fault on the wire (e→g10) untestable, the SMA e is a redundant SMA by definition. For the stuck-at −1 test on the wire (c→g10), c has an MA 0 for activating the fault effect. The irredundant SMAs a and b are both set to 0, and e is set to 1 for propagating the fault effect. The wire (c→g10) is redundant since c=0 and a=0 imply g5 605=0, and the fault effect is blocked at g11 610. The irredundant SMAs a and b in the AND(SMA) term are needed to set to specific values for the wire (c→g10)'s redundancy test. Redundant SMA can be removed from the rectification network, thus, FIG. 6b can be simplified as FIG. 6c.

Subsequently, SMA substitution is described.

To reduce the remaining irredundant SMAs into only one MA, it need to find an MA that can substitute for all irredundant SMAs. g1 can substitute for g2 if g1 implies g2. For each irredundant SMA, a set of MAs for substitution can be derived. Thus, an MA that is in the intersection of each irredundant SMA's substitution set can be identified for substituting for all SMAs. This MA is one end point of the alternative wire for the target wire. Next, the method to find an MA substituting for all irredundant SMAs is introduced.

Since the transitive fanin cones of SMAs contain no other MAs, the forward implication from SMAs is only considered in searching the candidates for SMA substitution. With the MAs implied from the stuck-at-fault test on wt and the SMA classification, the substitution relationships can be determined.

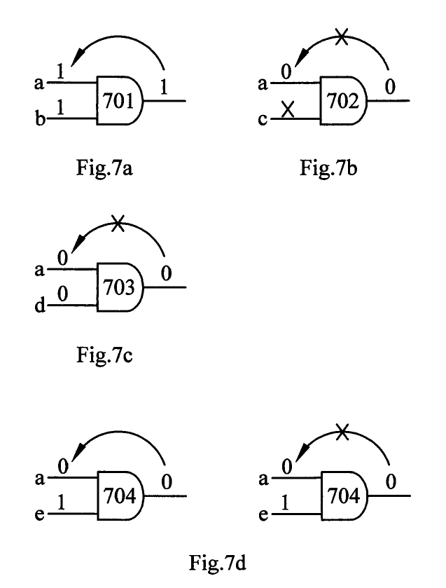

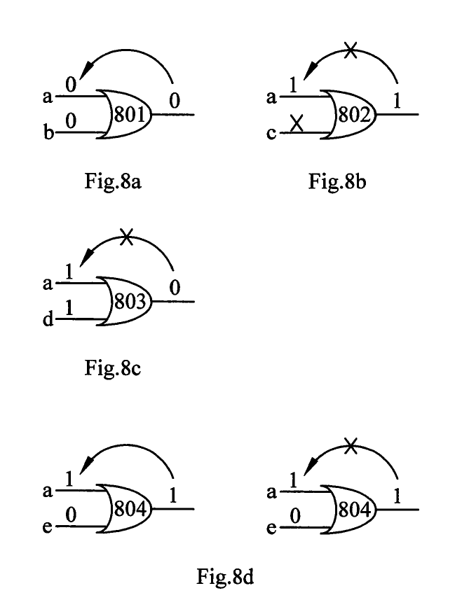

FIG. 7 lists all types of substitution relationships for an AND gate. Supposing a is an irredundant SMA and b, c, d, and e are known MAs. The purpose is to determine whether the value of a can be backwardly implied from the output of the gate. In FIG. 7a, a, b, and g1 701 are noncontrolling values. No matter b is a redundant SMA, g1=1 always implies a=1 and b=1. Hence, g1 can replace a. In FIG. 7b, a is a controlling value 0 and c is unknown, g2 702=0 can not imply a=0, so g2 can not replace a. In FIG. 7c, a, d, and g3 703 are the controlling values. No matter d is a redundant SMA, g3=0 cannot imply a=0, hence, g3 cannot replace a. In FIG. 7d, a is a controlling value 0 and e has a noncontrolling value 1. If e is a redundant SMA, g4 704=0 can imply a=0, and g4 can replace a. The types of substitution relationships for an OR gate are similar to an AND gate and are summarized in FIG. 8a˜8d.

For the last example in FIG. 6c, first, we find the substitution set for the irredundant SMA a. By referring FIG. 7d, the gate g6 606 can replace a since e is a redundant SMA. By referring FIG. 8a, the inputs are both noncontrolling values. Thus, g8 608 can replace g6 606. By referring FIG. 7d, the gate g9 609 cannot replace g8 608. Thus, the substitution set for the irredundant SMA a is {g6, g8}. Next, we find the substitution set for the irredundant SMA b. By the same manner as a, the substitution set for the irredundant SMA b is {g7 607, g8 608}. The intersection of the substitution sets of a and b is {g8}. Thus, g8 608 can substitute for g10 612 in the simplified rectification network 630 and the wire (g8 608→g11 610) is a single alternative wire for wt. The final circuit is as shown in FIG. 6d.

Next, we describe how to apply the IRRA technique for area optimization. The proposed algorithm contains two stages. The first stage greedily removes many target wires that have a common alternative wire. This stage straightforwardly minimizes the circuit area. The second stage, however, removes a target wire whose corresponding rectification network is large. Thus, the resultant circuit size becomes larger. The second stage acts as a stimulus for escaping from a local minimal point during the optimization process.

In the first stage, the alternative wires for a set of target wires are computed by the procedure described in above-mentioned. Then, a common alternative wire of these target wires is selected. We add this alternative wire to the circuit and remove the target wires which is the subset of the original target wires. This operation is a greedy approach for area optimization, which may easily be stuck at a local minimal point.

When the first stage cannot further minimize the circuit size, the second stage begins. A target wire which has only one fanout node or has no single alternative wires is selected in the second stage. The removal of this kind of target wire may result in the removal of multiple gates and significantly change the circuit structure by adding the rectification network. The algorithm is described as follows.

The first stage is repeated if it continuously decreases the circuit size. After each run of the first stage, a parameter n is increased with x % probability if a new minimal point is reached, where n is the default number of the second stage run. Then a second stage run is performed, and n is decreased. The algorithm is terminated when n is decreased to 0. The details of the experiments and parameters are presented in the following.

Two experiments are conducted to demonstrate the effectiveness of the proposed IRRA technique. The first one is for single alternative wire identification which is described in above-mentioned. This experiment would like to show the IRRA approach can find alternative wires for more target wires. The second one is for area optimization which is described in above-mentioned. This experiment would like to express the IRRA restructuring technique can avoid being stuck at a local minimal point during the optimization procedure.

The proposed single alternative wire identification algorithm was implemented in C and the experiments were conducted over a set of ISCAS85 and MCNC benchmarks within SIS (reference [10]) environment on a Sun Blade 2500 workstation with 4 GBytes memory. Since the circuits under consideration are the BLIF format and only consist of AND, OR, and INV gates, we decompose the complex gates into these primitive 2-input gates by using decomp tech network command in SIS. Additionally, recursive learning technique is applied in these experiments with depth=1.

Table I shows the results for the single alternative wire identification that compared with the previous work (reference [6]) on the same platform. Column 1 shows the name of the benchmarks. Column 2 shows the total number of target wires in each benchmark, Nt. Column 3 shows the number of target wires having alternative wires, Na, of our approach of the present invention. Column 4 and Column 6 show the percentage of target wires having alternative wires, %, in the reference [6] and the present invention, respectively. Column 5 and Column 7 show the CPU time of these two approaches measured in seconds. For example in c1908 circuit, our approach can find the single alternative wires for 1011 out of 1220 target wires. The percentage of target wires having single alternative wires, in the reference [6] and the present invention are 54.51% and 82.87%, respectively. The CPU time needed are 186.16 seconds and 70.5 seconds, respectively.

TABLE I

| | | | [6] | | ours | |
|---|---|---|---|---|---|---|
| Circuit | Nt | Na | % | Time (S) | % | Time (S) |
| c432 | 338 | 325 | 70.41 | 7.26 | 96.15 | 7.03 |
| c880 | 692 | 417 | 37.86 | 11.86 | 68.06 | 8.62 |
| c1908 | 1220 | 1011 | 54.51 | 186.16 | 82.87 | 70.5 |
| c2670 | 1348 | 830 | 42.06 | 111.28 | 61.57 | 69.9 |
| c3540 | 2336 | 1553 | 57.45 | 344.7 | 66.48 | 292.73 |
| c5315 | 4022 | 2560 | 52.71 | 492.42 | 63.65 | 294.23 |
| c7552 | 4946 | 3741 | 59.58 | 1314.87 | 75.64 | 627.8 |
| 9symml | 468 | 403 | 74.15 | 15.02 | 86.11 | 10.59 |
| alu2 | 898 | 741 | 84.52 | 164.45 | 82.52 | 47.62 |
| alu4 | 1794 | 1520 | 86.29 | 786.83 | 84.73 | 227.17 |
| apex6 | 1332 | 784 | 37.54 | 30.99 | 58.86 | 22.47 |
| apex7 | 512 | 406 | 66.99 | 9.1 | 79.3 | 5.03 |
| b9 | 258 | 241 | 67.05 | 2.27 | 93.41 | 1.41 |
| c8 | 436 | 312 | 65.37 | 17.83 | 71.56 | 5.32 |
| cc | 154 | 151 | 74.68 | 1.41 | 98.05 | 0.51 |
| cm85a | 88 | 78 | 63.64 | 0.29 | 88.64 | 0.2 |
| comp | 194 | 166 | 74.23 | 2.04 | 85.57 | 1.31 |
| cu | 142 | 130 | 88.03 | 2.41 | 91.55 | 0.68 |
| dalu | 2904 | 2319 | 67.98 | 3503.56 | 79.86 | 396.69 |
| example2 | 578 | 450 | 48.1 | 17.78 | 77.85 | 6.61 |
| frg2 | 3250 | 2760 | 78.98 | 3138.16 | 84.92 | 333.4 |
| go | 134 | 120 | 76.12 | 1.05 | 89.55 | 0.52 |
| il0 | 4620 | 3425 | 59.03 | 2629.4 | 74.13 | 1188.63 |
| lal | 374 | 336 | 78.07 | 11.78 | 89.84 | 3.51 |
| mux | 112 | 76 | 54.46 | 0.7 | 67.86 | 0.38 |
| pair | 3038 | 2124 | 51.88 | 309.23 | 69.91 | 162.24 |
| pcler8 | 156 | 107 | 58.33 | 1 | 68.59 | 0.6 |
| pm1 | 134 | 119 | 77.61 | 1.01 | 88.81 | 0.52 |
| rot | 2242 | 2016 | 83.32 | 583.66 | 89.92 | 189.77 |
| sct | 382 | 357 | 86.13 | 21.11 | 93.46 | 7 |
| term1 | 980 | 831 | 82.45 | 69.89 | 84.8 | 26.84 |
| ttt2 | 738 | 672 | 87.53 | 51.88 | 91.06 | 12.68 |
| unreg | 224 | 130 | 35.71 | 1.13 | 58.04 | 0.71 |
| x3 | 2523 | 1958 | 74.35 | 452.73 | 77.51 | 93.27 |
| x4 | 1364 | 1257 | 84.97 | 231.89 | 92.16 | 39.02 |
| Total | 44934 | 34480 | 64.71 | 14527.21 | 76.73 | 4155.51 |
| Ratio1 | — | — | 1 | — | 1.19 | — |
| Ratio2 | — | — | — | 1 | — | 0.29 |

According to Table I, our approach gets 19% improvement on the percentage of target wires having alternative wires, and only requires 29% CPU time of the reference [6]. It shows that one-stage IRRA approach is more efficient and more effective on the single alternative wire identification as compared with the reference [6].

The area optimization algorithm with IRRA technique was implemented on the same platform as the first experiment. The values of parameters n and x are 3 and 10 in the experiments. That means the times of second stage increase with 10% probability after each run of the first stages if a new minimal point is reached. The benchmark circuits are initialized by using script.algebraic command, and we compare the results of IRRA approach against that of SIS and Perturb/Simplify algorithm in the reference [4] in term of the number of 2-input gates.

In Table II, the results in Column SIS are the best results obtained by the commands script.algebraic or script.boolean. The command script.rugged is not used since it fails on optimizing some circuits within the space/time limit. For example, alu2 circuit has 364 gates by using the script of SIS. It is optimized to 281 gates by using Perturb/Simplify algorithm in the reference [4] in 1127.4 seconds. With our approach of the present invention, however, only 255 gates are left in 289.01 seconds. According to Row Ratio1 in Table II, our results are 19% smaller than that obtained by SIS in terms of the number of 2-input gates. As compared with the reference [4], the IRRA approach with this preliminary implementation is also competitive. All the optimized results have been verified against the original circuit by using the verification command verify in SIS.

TABLE II

| | SIS | [4] | | ours | |
|---|---|---|---|---|---|
| Circuit | \| gate \| | \| gate \| | Time(S) | \| gate \| | Time(S) |
| 9sysmml | 209 | — | — | 179 | 360.73 |
| c432 | 193 | — | — | 129 | 79.43 |
| c880 | 357 | — | — | 310 | 119.9 |
| c1908 | 400 | — | — | 360 | 977.68 |
| c2670 | 654 | — | — | 560 | 1306.72 |
| c3540 | 1057 | 938 | 5692.8 | 969 | 1099.96 |
| c5315 | 1532 | 1321 | 2236.7 | 1391 | 3852.46 |
| c7552 | 1892 | 1426 | 3668.6 | 1466 | 12526.04 |
| alu2 | 364 | 281 | 1127.4 | 255 | 289.01 |
| alu4 | 699 | 555 | 4171.5 | 549 | 1111.87 |
| apex6 | 644 | 543 | 568.9 | 537 | 192.15 |
| apex7 | 200 | — | — | 158 | 69.87 |
| comp | 118 | 84 | 51.9 | 78 | 37.64 |
| dalu | 1150 | — | — | 758 | 357 |
| f51m | 116 | 78 | 4.7 | 72 | 22.55 |
| frg2 | 797 | — | — | 649 | 206.85 |
| pcler8 | 71 | 64 | 29.7 | 64 | 9.43 |
| rot | 563 | 452 | 256 | 460 | 160.78 |
| term1 | 202 | 113 | 56.2 | 97 | 24.68 |
| ttt2 | 172 | 118 | 57.8 | 115 | 62.07 |
| x3 | 614 | 552 | 472 | 554 | 204.56 |
| x4 | 308 | — | — | 276 | 30.33 |
| Total1 | 12443 | — | — | 10105 | 23247.01 |
| Ratio1 | 1 | — | — | 0.81 | — |
| Total2 | — | 6641 | 18423.3 | 6726 | 19704.36 |
| Ratio2 | — | 1 | 1 | 1.01 | 1.07 |

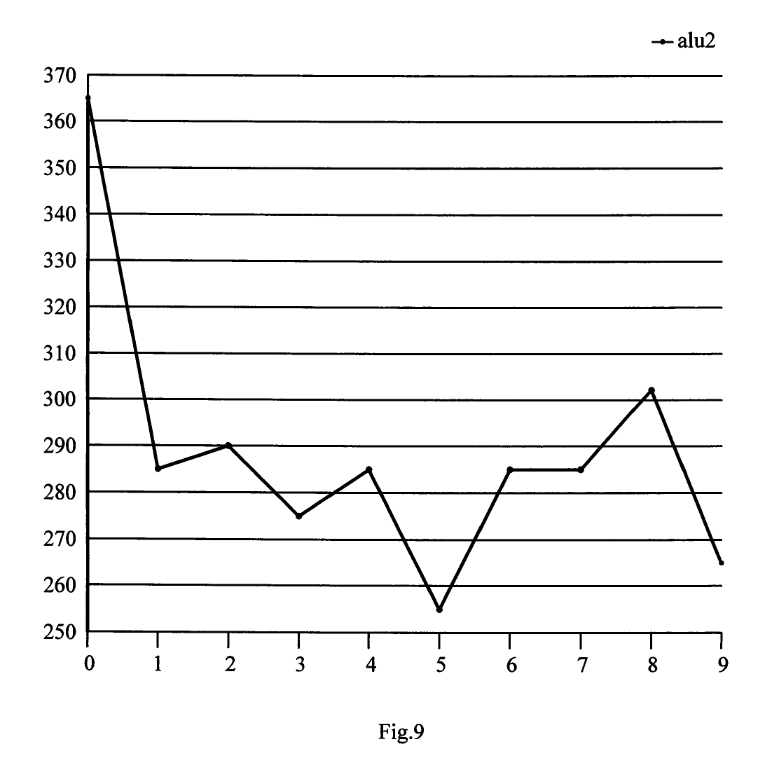

The detailed analysis of area optimization by using IRRA approach for the circuit alu2 is also shown in FIG. 9. Iterations 1, 3, 5, 7, and 9 are the points to start the second stage where are the local optimal points. Iterations 2, 4, 6, and 8 are the points after the IRRA is applied. It can be seen that the IRRA technique optimizes the circuit area by escaping the local optimal points.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. A circuit restructuring method, comprising:
removing an irredundant target wire by constructing a corresponding rectification network;
adding a redundant wire in a circuit; and
applying a stuck-at fault test on said redundant wire.

2. The method of claim 1, wherein said rectification network comprises a Exact Removal Network (ERN).

3. The method of claim 2, wherein said Exact Removal Network (ERN) is to rectify the error result from the value at the output of said irredundant target wire's dominator that changed from 1 to 0 after the removal of said irredundant target wire and applying said stuck-at fault test.

4. The method of claim 2, wherein said Exact Removal Network (ERN) is implicated by the SMAs obtained from said stuck-at fault test.

5. The method of claim 1, wherein said rectification network comprises a Exact Addition Network (EAN).

6. The method of claim 5, wherein said Exact Addition Network (EAN) is to rectify the error result from the value at the output of said target wire's dominator that changed from 0 to 1 after the removal of said irredundant target wire and applying said stuck-at fault test.

7. The method of claim 5, wherein said Exact Addition Network (EAN) is implicated by said SMAs obtained from said stuck-at fault test.

8. The method of claim 1, wherein a destination gate is one of the dominators of said irredundant target wire.

9. The method of claim 1, further comprising a SMA classification step to decrease the number of SMAs in said rectification network.

10. The method of claim 9, wherein said SMA are classified into irredundant MA, independent-redundant MA and dependent-redundant MA.

11. The method of claim 10, wherein said independent-redundant MA and said dependent-redundant MA can be removed from said rectification network.

12. The method of claim 1, further comprising a SMA substitution step to find the single alternative wire of said irredundant target wire.
